(19) United States
(12) Patent Application Publication
(10) Pub. No.: US 2026/0148353 A1
(43) Pub. Date: May 28, 2026

(54) DEBLURRING OF DISTORTION-CORRECTED IMAGES

(71) Applicant: Varjo Technologies Oy, Helsinki (FI)

(72) Inventor: Mikko Ollila, Tampere (FI)

(73) Assignee: Varjo Technologies Oy, Helsinki (FI)

(21) Appl. No.: 18/961,858

(22) Filed: Nov. 27, 2024

(51) Int. Cl. G06T 5/73; G06F 3/01; G06T 5/20; G06T 5/60; G06T 5/80

(52) U.S. Cl. CPC G06T 5/73; G06F 3/013; G06T 5/20; G06T 5/60; G06T 5/80; G06T 2207/10016; G06T 2207/20084; G06T 2207/20192

(57) ABSTRACT

A method for deblurring distortion-corrected images, includes: obtaining a video-see-through (VST) image of a real-world environment; determining a given region of the VST image, based on at least one of: a distortion profile of a camera lens of at least one VST camera, blur characteristics of the camera lens, a scaling ratio between a resolution of the at least one VST camera and a resolution of a display whereat the VST image is to be displayed; and performing an undistortion deblurring operation on the given region of the VST image, by utilising at least one of: (i) a deblurring deconvolution filter, (ii) at least one neural network, based on locations of pixels of the given region, to generate an output image.

### TECHNICAL FIELD

The present disclosure relates to methods for deblurring distortion-corrected images. Moreover, the present disclosure relates to systems for deblurring distortion-corrected images.

### BACKGROUND

Video see-through systems, such as those used in augmented reality (AR) and mixed reality (MR) applications, rely heavily on wide-angle lenses to provide users with a wide field of view (FOV). However, such wide-angle lenses often introduce significant geometric distortion (for example, such as a pincushion distortion or a barrel distortion), particularly, towards a peripheral region of an image that is captured using a camera comprising such wide-angle lenses. Therefore, to ensure an immersive and accurate viewing experience, it is essential to correct such a geometric distortion for restoring a natural geometry of the image. Some systems avoid severe distortion by using lenses with inherent low distortion, but this often comes at a cost of a reduced FOV of the image, limiting a realistic and an immersive viewing experience of the user. Moreover, some lenses exhibit varied pixels-per-degree (PPD) characteristics across a field of view of an image. For example, lenses designed with a zero distortion may achieve highest PPD values near a peripheral region of the image. Conversely, lenses designed with a high distortion may achieve highest PPD values at a central region of the image, where a focus of the user is typically concentrated. However, such a design often results in a reduction in pixel density towards the peripheral region of the image.

Despite several advancements in existing image processing technology, maintaining an image clarity/sharpness throughout a field of view of the image after performing the distortion correction, remains a key challenge. Conventionally, in cases where the wide-angle lenses introduce severe distortion, particularly with a non-uniform pixels-per-degree (PPD) distribution across the FOV of the image, existing image processing technology struggle to preserve image clarity of images. As a result, correcting the severe distortion often results in a noticeable blurring, especially towards the peripheral region of an image, where fewer pixels are available to represent a part of a visual scene. Furthermore, such a blurring is further exacerbated when a display resolution of a display (whereat the image is to be displayed) is significantly higher than the PPD provided by the wide-angle lenses used in the camera, magnifying even small imperfections (such as a small motion blur) after undistortion. Typically, when lenses have a low modulation transfer function (MTF) resolution towards the peripheral region, they do not transmit contrast as effectively as they do at a central region of the image. Such a problem is compounded by a fact that any low-contrast details, especially those that are slightly blurred, become even more blurred when they are upscaled to fit the display resolution. This results in a scenario where the peripheral region of the image, which are already prone to distortion and blurring, become even more blurred and out-of-focus after undistortion. The wide-angle lenses with variable focal lengths introduce non-linear distortion, which changes dynamically as wide-angle lens is adjusted. As a result, the existing image processing technology is incapable of taking into account such spatial distortion changes, leaving a significant gap in achieving both accurate and high-quality visual correction. These limitations highlight the need for an improved solution that addresses persistent challenges in modern video see-through systems.

Therefore, in light of the foregoing discussion, there exists a need to overcome the aforementioned drawbacks.

### SUMMARY

The aim of the present disclosure is to provide a method and a system which facilitate in generating output images upon deblurring distortion-corrected images, wherein said output images are highly accurate, realistic, and blur-free. Due to this, an overall viewing experience of a user is improved, when said output images are displayed to the user. The aim of the present disclosure is achieved by a method and a system for deblurring distortion-corrected images, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates steps of a method for deblurring distortion-corrected images, in accordance with an embodiment of the present disclosure;

FIG. 2 illustrates a block diagram of an architecture of a system for deblurring distortion-corrected images, in accordance with an embodiment of the present disclosure; and

FIGS. 3A, 3B, 3C, and 3D, FIG. 3A illustrates an exemplary video-see-through (VST) image captured using a VST camera, FIG. 3B illustrates an exemplary distortion-corrected VST image, FIG. 3C illustrates an exemplary output image, while FIG. 3D illustrates an exemplary in-painted output image, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a method for deblurring distortion-corrected images, wherein the method comprises:
obtaining a video-see-through (VST) image of a real-world environment;
determining a given region of the VST image, based on at least one of: a distortion profile of a camera lens of at least one VST camera, blur characteristics of said camera lens, a scaling ratio between a resolution of the at least one VST camera and a resolution of a display whereat the VST image is to be displayed; and
performing an undistortion deblurring operation on the given region of the VST image, by utilising at least one of: (i) a deblurring deconvolution filter, (ii) at least one neural network, based on locations of pixels of the given region, to generate an output image.

In a second aspect, the present disclosure provides a system for deblurring distortion-corrected images, wherein the system comprises:
at least one video-see-through (VST) camera; and
at least one processor configured to:
   control the at least one VST camera to capture a VST image of a real-world environment;
   determine a given region of the VST image, based on at least one of: a distortion profile of a camera lens of at least one VST camera, blur characteristics of said camera lens, a scaling ratio between a resolution of the at least one VST camera and a resolution of a display whereat the VST image is to be displayed; and
   perform an undistortion deblurring operation on the given region of the VST image, by utilising at least one of: (i) a deblurring deconvolution filter, (ii) at least one neural network, based on locations of pixels of the given region, to generate an output image.

The present disclosure provides the aforementioned method and the aforementioned system for deblurring distortion-corrected images. Herein, by determining the given region in the VST image, the method and the system enable in providing a targeted and efficient approach for correcting a blurriness in the distortion-corrected images. This enables in improving a visual quality of the given region in the VST image that have been affected by lens distortion or blurriness upon correcting distortion. The method and the system facilitate in correcting regions of the VST image that are affected or likely to be affected by distortion and blur, rather than applying unnecessary corrections to an entirety of the VST image. Hence, such type of targeted deblurring not only enhances an overall visual quality of the image, but also significantly reduces computational overhead, resulting in faster processing times. Beneficially, a use of the at least one of: the deblurring deconvolution filter, the at least one neural network provides a flexibility and an improved accuracy in performing the undistortion deblurring operation. This is because by providing locations of pixels of the given image that likely require undistortion deblurring, both the deblurring deconvolution filter and the at least one neural network facilitates in generating blur-free, distortion-free, highly-realistic output images, preserving fine details in the output images while effectively mitigating artifacts introduced during a distortion correction process. This improves an overall viewing experience of the user (for example, in terms of realism and immersiveness), when the output images are displayed to the user.

The term “deblurring” refers to a process of reducing blurring artifacts present in an image. Typically, blurring can occur due to various factors, for example, such as a camera motion, an optical aberration, a defocus, or similar, resulting in a loss of sharpness and detail in the image being captured using a camera. Thus, a deblurring process aims to restore a clarity/sharpness in the image, for example, by reversing or mitigating effects due to the blurring. The term “distortion-corrected images” refer to images that have undergone a geometric correction to compensate for distortions introduced by a lens system of the camera. Typically, a distortion correction is a computational process that rectifies the image, restoring intended proportions and linearity, but may introduce artifacts such as blurring, especially towards peripheral region(s) of the image.

Throughout the present disclosure, the term “video-see-through image” refers to a visual representation of a real-world environment captured by one or more cameras and displayed on a display of a device. The term “visual representation” encompasses colour information represented in the VST image, and additionally optionally other attributes (for example, such as depth information, transparency information, luminance information, brightness information, and the like) associated with the VST image. In augmented reality (AR) systems or mixed reality (MR) systems, the VST image is typically captured using outward-facing cameras mounted on the device (for example, such as head-mounted display (HMD) device), allowing user to view their surroundings with overlaid virtual content. The device could, for example, be the HMD device. It will be appreciated that obtaining the VST image of the real-world environment enables for a real-time visual representation of physical surroundings, which may be essential for augmented and mixed reality applications. By capturing the VST image, the at least one processor can accurately track and reflect changes in the user's environment, ensuring that virtual objects are consistently aligned with the physical surroundings. This process enhances immersive experience of the user, enabling precise overlay of digital content onto a representation of the real-world environment, while also supporting dynamic adjustments based on movement or environmental changes. Herein, the VST image is captured using the at least one VST camera that is optionally mounted on the device, wherein the at least one VST camera faces the real-world environment. It will be appreciated that the VST image is obtained with a known distortion profile, typically due to the camera lens, which will later be rectified through image processing techniques like distortion correction and the undistortion deblurring operation.

Throughout the present disclosure, the term “region” refers to an area within the VST image that is identified for processing based on its susceptibility to a blur that occurs upon distortion correction. The term “distortion profile” refers to a quantitative characterisation of how the camera lens alters a geometry of a captured image. Typically, the distortion profile outlines specific types and extents of distortion introduced by the camera lens, such as a barrel distortion, a pincushion distortion, or other non-linear distortions. Notably, the distortion profile is essential for understanding how straight lines and shapes within the VST image are warped, thereby guiding subsequent image processing operations to correct these distortions and restore a natural appearance of visual representation in the VST image. Examples of the camera lens may include, but are not limited to, a wide-angle lens, a fisheye lens, a telephoto lens, a macro lens, a zoom lens, and similar.

Optionally, the at least one VST camera is implemented as a visible-light camera. Examples of the visible-light camera include, but are not limited to, a Red-Green-Blue (RGB) camera, a Red-Green-Blue-Alpha (RGB-A) camera, a Red-Green-Blue-Depth (RGB-D) camera, an event camera, a Red-Green-Blue-White (RGBW) camera, a Red-Yellow-Yellow-Blue (RYYB) camera, a Red-Green-Green-Blue (RGGB) camera, a Red-Clear-Clear-Blue (RCCB) camera, a Red-Green-Blue-Infrared (RGB-IR) camera, and a monochrome camera. Additionally, optionally, the at least one VST camera is implemented as a depth camera. Examples of the depth camera include, but are not limited to, a Time-of-Flight (ToF) camera, a light detection and ranging (LiDAR) camera, a Red-Green-Blue-Depth (RGB-D) camera, a laser rangefinder, a stereo camera, a plenoptic camera, an infrared (IR) camera, a ranging camera, a Sound Navigation and Ranging (SONAR) camera. Optionally, the at least one VST camera is implemented as a combination of the visible-light camera and the depth camera. In some implementations, the at least one VST camera is an autofocus camera. In other implementations, the at least one VST camera is a fixed focus camera. Optionally, the at least one VST camera comprises a depth camera.

Notably, the VST image is analysed by the at least one processor to identify the given region that likely requires deblurring. The given region may be characterised by higher levels of distortion and blur, which negatively impacts an overall sharpness of the VST image. Herein, a determination of the given region of the VST image based on the distortion profile of the camera lens may involve analysing how the camera lens distorts different parts of the VST image. This is possible because the distortion profile provides a mathematical representation or mapping of how the camera lens modifies a visual scene, including details on a nature and an extent of distortions across the VST image. In order to determine the given region, the at least one processor may retrieve the distortion profile, which can either be predefined based on specifications of the camera lens or generated in real-time through calibration of a given VST camera. The at least one processor then utilises the distortion profile to analyse the VST image, identifying regions that were most affected by distortion during capturing the VST image. Typically, such regions are often located near edges or corners of the VST image, especially, in cases where wide-angle lenses or fisheye lenses are employed for image capturing; but this may vary depending on characteristics of the lens. In a first example, a given VST camera may comprise with a fisheye lens. The fisheye lens typically exhibits a significant barrel distortion, where straight lines appear curved, and objects near periphery of the image are stretched or warped. The distortion profile for the fisheye lens indicates that peripheral areas, especially near edges and/or corners, of the image may experience most severe distortion. By utilising such information, the at least one processor may identify a group of pixels representing said edges and/or corners, and the given region comprises the group of pixels, where blurring artifact is most likely to occur after the distortion correction.

Moreover, the determination of the given region of the VST image based on the blur characteristics of the camera lens may involve analysing how the camera lens contributes to image blur during capture. The blur characteristics may arise from various factors, for example, such as lens aberrations, focus inaccuracies, motion during image acquisition, and similar. By understanding such characteristics, the at least one processor can effectively identify which areas of the VST image may require corrective actions to restore clarity/sharpness. In this regard, the at least one processor optionally analyse the blur characteristics, which can be represented by a blur kernel or a set of metrics that describe the nature and extent of the blur introduced by the lens. Such an assessment may be based on predefined parameters for specific types of lenses or determined through real-time calibration. Typically, the blur characteristics indicate how different areas of the VST image are affected by the blur, often highlighting regions that are out of focus or where motion has occurred during capturing of the VST image. Continuing with the first example, consider a scenario where the given VST camera may capture an image of a moving object (for example, such as a person walking in the real-world environment). Due to the movement of the object, the camera lens may introduce a motion blur, particularly in regions corresponding to a path of the moving object. The blur characteristics would identify these regions as having increased blur, often manifested as streaks or smearing along a direction of motion. Using said information, the at least one processor analyses the captured VST image, applying the identified blur characteristics to determine the given region that exhibits significant blur. In aforesaid example, the at least one processor may pinpoint areas in the VST image where the moving object appears smeared or less distinct, focusing on those regions for corrective processing. Once the given region is determined based on the at least one of: the distortion profile of the camera lens, the blur characteristics of the said camera lens, the at least one processor can prioritise the given region for the undistortion deblurring operation. It will be appreciated that by determining the given region, the method and the system aim to enhance the undistortion deblurring operation, ensuring that corrections are applied precisely where they are needed to restore a visual quality (such as a sharpness) of the VST image without affecting other parts of the VST image that may be less or not impacted. The display could, for example, be a display of an HMD device or even a remote VR display that is used to view camera stream remotely (live or playback).

It will be appreciated that alternatively or addition to using the distortion profile and the blur characteristics of the camera lens, the scaling factor can also be used to determine which region(s) of the VST image that needs undistortion deblurring. The term “scaling ratio” refers to a ratio between a resolution at which the image is displayed on the display and a resolution at which the at least one VST camera captures a visual scene. When the scaling ratio is high, the display has a significantly higher PPD than the camera, and any blur in the captured VST image would likely become magnified when displayed at the display. This makes the blur in specific regions more noticeable and potentially distracting. By ascertaining the scaling ratio, the at least one processor can easily identify said specific regions in the VST image where blur due to a high scaling ratio is particularly pronounced. For example, regions captured at a low camera resolution that are being upscaled for a high-resolution display may likely need more undistortion deblurring because the blur is “stretched” over more pixels on the display. It will be appreciated that in regions where the scaling ratio is close to 1 (i.e., a display PPD is similar to a camera PPD), blur might be less noticeable, and less undistortion deblurring correction may be needed. Using the scaling ratio as a basis for determining the given region allows for more precise and efficient processing. Instead of performing the undistortion deblurring uniformly across a field of view of the VST image, the at least one processor can focus on regions where the scaling ratio makes blur more visible, leading to an improved, targeted blur correction. In other words, incorporating the scaling ratio enables the at least one processor to dynamically assess and enhance image quality based on how much the camera's resolution is magnified on the display. This may also complement the distortion profile and the blur characteristics, thereby resulting in sharp, high-resolution images, especially in high-scaling regions. It will be appreciated that a structure, a texture, and an appearance of a noise in the VST image are influenced by the scaling ratio, and therefore must be accounted for in a processing of the VST image.

Optionally, the scaling ratio is spatially varying across a field of view of the VST image. In this regard, the scaling ratio may not always be uniform across the image, instead, it can vary spatially across different regions of the VST image. Such a spatial variability arises because the camera PPD and the display PPD can vary significantly, and sometimes even in opposite directions. For example, the PPD at a center might be higher than at edges for the camera, while the display might have a different spatial PPD distribution, resulting in a scaling ratio that changes across the VST image. Typically, this may occur because cameras often have optical designs where a pixel density varies across the field of view. For example, in lenses with distortion (such as wide-angle lenses or fisheye lenses), the camera PPD is typically highest at the center and decreases toward the edges. Similarly, displays (especially those used in augmented or virtual reality systems) may also exhibit a non-uniform PPD. For example, displays might have higher resolution near a center of a visual field (where a user's gaze is typically focussed) and a lower resolution at its periphery. It is to be noted that PPD variations of the camera and the display may not align. For example, the camera may concentrate pixels at the center (high PPD in the center, lower at edges), but the display may distribute pixels differently, perhaps more evenly or even emphasizing edges. When these differing PPD distributions are compared, the scaling ratio can vary across the field of view of the VST image. This means that some regions of the image will be upscaled more than others. A scaling ratio which accounts for spatial variations due to differing PPD distributions of the camera and the display is particularly important for handling regions where scaling may amplify blur more prominently, ensuring the undistortion deblurring operation remains effective across an entirety of the VST image. This is because regions with higher scaling ratios will exaggerate blur more, making these areas require more precise deblurring operations, and vice versa. Alternatively, optionally, the scaling ratio is uniform across a field of view of the VST image.

Optionally, the given region is at least one of: a gaze region of the VST image, at least a part of a peripheral region of the VST image. In this regard, the term “gaze region” refers to a region of the VST image onto which a gaze direction is mapped. The gaze region may, for example, be a central region of the VST image, a top-left region of the VST image, a bottom-right region of the VST image, or similar. The term “peripheral region” refers to another region in the VST image that surrounds the gaze region. The another region may, for example, remain after excluding the gaze region from the VST image. Herein, the gaze region may be determined using eye-tracking technology or algorithms that analyse a visual fixation of the user, enabling the at least one processor to identify where the user is looking. Such information is utilised when performing deblurring, to ensure that a region of interest receives priority for blurring corrections. The given region of the VST image may comprise a plurality of pixels. Optionally, an angular width of the peripheral region lies in a range of 12.5-50 degrees from a gaze position to 45-110 degrees from the gaze position, while an angular extent of the gaze region lies in a range of 0 degree from the gaze position to 2-50 degrees from the gaze position.

Once the gaze region and the peripheral region are determined, the undistortion deblurring operations can be then applied specifically to these areas. It will be appreciated that prioritizing the gaze region, the method ensures that undistortion deblurring operations are concentrated on the area that is most relevant to the user's experience, thereby enhancing a visual clarity where it is needed most. Such a targeted approach not only improves an overall viewing experience of the user, but also reduces a utilisation of computational resources by limiting intensive processing to specific image areas, rather than processing an entirety of the VST image. It will also be appreciated that analysis of at least the part of the peripheral region enables for identification and correction of blurring upon distortion correction that may not be as immediately visible but can detract from an overall image quality of the image. By addressing such a peripheral blurring upon distortion correction, the method contributes to a seamless and realistic visual experience. Moreover, utilising both the eye-tracking technology and image processing techniques enhances an adaptability of the system, enabling real-time adjustments to undistortion deblurring operations based on a user's gaze. Such a dynamic adjustment not only results in an improved image quality (for example, in terms of a high resolution), but also facilitates in providing an immersive user experience, as the user can engage with augmented-reality or mixed-reality applications more intuitively and effectively. A technical effect of the aforementioned feature is that it enables an adaptive and prioritised deblurring of the given region within the VST image thereby enhancing the overall image quality of the VST image while optimising computational efficiency.

Throughout the present disclosure, the term “undistortion deblurring” refers to a process of correcting a blur that arises due to a rectification of a distortion in an image (namely, undistortion). The term “output image” refers to a final processed image generated after applying the undistortion deblurring operation to the given region of the VST image. Optionally, the output image can be processed further to generate an extended-reality (XR) image. Herein, the term “deblurring deconvolution filter” refers to a mathematical algorithm employed to reverse effects of blurring in an image by estimating an original sharp image from a blurred input. The deblurring deconvolution filter typically operates on a principle of deconvolution, which separates a convolution of an original image with a point spread function (PSF) that describes a blurring process.

Once the given region of the VST image is determined, the next step involves mapping the pixel locations in the given region. Each pixel in the VST image corresponds to a particular real-world location captured by the at least one VST camera, but due to the at least one of: the distortion profile of the camera lens of the at least one VST camera, the blur characteristics of the said camera lens, the pixels in the distorted image do not accurately represent the real-world geometry. Herein, the undistortion deblurring operation uses the deblurring deconvolution filter applied to the given region, identified as being affected by blur and distortion. In this regard, the deblurring deconvolution filter operates on a pixel-by-pixel basis within the given region of the VST image. The pixel locations within the given region are essential because a degree of blurring and distortion may vary across different parts of the VST image. For each pixel in the given region of the VST image, the deblurring deconvolution filter performs a mathematical operation to reverse the effects of the blur by applying inverse of the blur kernel. The deblurring deconvolution filter may leverage various techniques, for example, such as point spread function (PSF) modelling, regularization algorithms, optimization algorithms, and similar, to achieve stable and visually acceptable output images, even in case of incomplete visual information in the VST image. In this regard, the PSF modelling may describe the distortion or blurring characteristics of the camera lens and may differ depending on where the pixel is located in the VST image. The deblurring deconvolution filter dynamically adjusts its deblurring operation for each pixel in the given region, based on its location and specific PSF affecting the given region. Such a targeted approach ensures that the undistortion deblurring process is both localized and precise, correcting the VST image according to a specific nature of the distortion affecting each pixel. Moreover, the deblurring deconvolution filter works iteratively over all the pixels in the given region, applying an inverse kernel to estimate and sharpen original scene details in the VST image. After the deblurring deconvolution filter has been applied to the given region, the output image is generated (keeping unprocessed areas in the VST image unchanged). The output image accurately represents a real-world scene with a negligible blur and corrected distortion.

Optionally, the deblurring deconvolution filter has a spatially-varying deblurring kernel. In this regard, the term “spatially-varying deblurring kernel” refers to a mathematical function used in image processing, wherein characteristics of a kernel (for example, such as its size, shape, orientation, or intensity) are dynamically adjusted, based on spatial location of the pixels within the VST image. This is crucial for handling non-uniform blur, which might vary across the VST image due to different degrees of distortion or optical depth of the pixels. The variation of the spatially-varying deblurring kernel is guided by factors, for example, such as a depth of field, a distortion profile, the blur characteristics of the camera lens, and the like. The technical benefit of utilising the spatially-varying deblurring kernel within the deblurring deconvolution filter is that it facilitates in accurately addressing varying levels of blur across different regions of the VST image. This significantly improves an overall image quality by enabling localised corrections tailored to a specific distortion characteristics encountered by each pixel of a given region. Moreover, the spatially-varying deblurring kernel enables in improving a restoration process, reducing artifacts and preserving important image details that might otherwise be lost in the VST image. Consequently, this not only increases an effectiveness of the undistortion deblurring operation but also enhances an overall computational efficiency of the at least one processor, allowing for faster processing times without compromising a visual fidelity of the output image.

In an example, in the VST image, a central portion may contain a well-defined object (namely, a person's face) captured at a distance of 2 meters from the camera lens. In this regard, the spatially-varying deblurring kernel may be configured as a small, such as a circular kernel with a radius of 3 pixels, which targets fine details of the person's face, ensuring that features like eyes, nose, and mouth are restored with high precision. Conversely, if the periphery of the image may capture a blurred background containing trees located further away around 10 meters from the camera lens. Due to a greater distortion and blur affecting this area, the spatially-varying kernel may dynamically adjust to a larger size, as compared to the previous scenario. Such a larger kernel spreads its influence over a wider area, effectively correcting the more severe blur and distortion that occurs with objects at greater depths.

It will be appreciated that the deblurring deconvolution filter has a spatially-varying deblurring kernel, this includes a possibility of accounting for spatially-varying scaling factors. Such a type of filter would dynamically adapt the spatially-varying deblurring kernel based on a position within an image to correct for blur patterns that vary across its field of view, often due to lens distortion. Additionally, if certain regions of the image are subject to different scaling factors, such as areas upscaled more significantly to match display resolution, the spatially-varying deblurring kernel could adjust accordingly. This means it would recognize and counteract a unique blur introduced by scaling differences, ensuring that the undistortion deblurring operation would be effective and consistent across the image.

Optionally, the deblurring deconvolution filter is any one of: a wiener filter, a Lucy-Richardson deconvolution filter. In this regard, the term “wiener filter” refers to a mathematical tool used in image restoration process to reduce a blur and/or a noise in an image. Typically, the wiener filter operates by applying an optimal deconvolution based on both statistical properties of a blurred image (arising from the distortion profile of the camera lens) and a noise present in the image. The noise present in the image refers to an unwanted random variation in pixel values that can degrade a quality and clarity of the image. The wiener filter adapts its deblurring strength according to spatial characteristics of the given region of the VST image. The wiener filter calculates most-likely estimate of the original image by minimising a mean square error between a deblurred image and an actual image, accounting for pixel locations and their distortions. This ensures that the output image is generated (upon correction or applying the undistortion deblurring) with an enhanced clarity and reduced artifacts, even in regions where both significant distortion and noise are present. Beneficially, by minimizing the mean square error, the wiener filter ensures that the output image has a reduced noise, sharp visual details, and minimal artifacts.

Further, the term “Lucy-Richardson deconvolution filter” refers to an iterative image restoration algorithm that addresses an image blur caused by known distortions in the VST image. The Lucy-Richardson deconvolution filter works by iteratively refining an estimate of an original, sharp image using the distortion profile of the camera lens. The Lucy-Richardson filter adjusts its deblurring process based on characteristics of the given region of the VST image where blur and distortion may vary spatially. By applying this iterative approach, the Lucy-Richardson deconvolution filter effectively reduces blur and enhances details, particularly in regions with severe optical distortions, resulting in a clearer and more accurate output image for the user. Moreover, the Lucy-Richardson deconvolution filter aims to recover the original image by using a known point spread function (PSF). By utilizing the known PSF, the Lucy-Richardson deconvolution filter ensures precise and targeted deblurring, particularly in regions of the VST image where distortion is more pronounced. This iterative nature of the Lucy-Richardson deconvolution filter enhances the accuracy of detail recovery, leading to the output image that exhibits sharper clarity, reduced blur, and minimized artifacts. The technical effect of the deblurring deconvolution filter being any one of: the wiener filter, the Lucy-Richardson deconvolution filter is that the undistortion deblurring operation is dynamically improved for each pixel based on its location, allowing for precise correction of varying levels of distortion and blur across the VST image. The wiener filter and the Lucy-Richardson deconvolution filter are well-known in the art.

Notably, the undistortion deblurring operation on the given region of the VST image is performed by utilising the at least one neural network, in addition to the deblurring deconvolution filter or without employing the deblurring deconvolution filter. Optionally, in this regard, the at least one neural network may be pre-trained on a large dataset of paired images, wherein each pair comprises a ground-truth image and a corresponding distortion-corrected, blurred image. Such images include various degrees of blur with known distortion profiles and blur characteristics such as those introduced by the camera lens. Once the given region of the VST image is determined, pixel data within the given region is extracted and fed into the at least one neural network. An input to the at least one neural network includes not only pixel values of the distortion-corrected, blurred image that is to be corrected, but may also include a corresponding ground-truth image (namely, a reference image or a high-quality image), as well as additional contextual information such as the distortion profile of the camera lens, the blur characteristics, and the pixel locations within the given region. This aids the at least one neural network in understanding how the distortion-corrected, blurred image deviates from the ground-truth image. It will be appreciated that the input is provided to the at least one neural network both in a training phase of the at least one neural network and in an inference phase of the at least one neural network (i.e., when the at least one neural network is utilised after it has been trained). In this regard, the at least one neural network compares the distorted, blurred image to the ground-truth image by extracting important features from both inputs. This comparison enables the at least one neural network to recognise patterns in distortions and blur, enabling it to learn how to correct distortion-corrected, blurred VST images. By analysing differences between reference images and distortion-corrected, blurred images, the at least one neural network corrects complex, non-linear distortions and blurs, generating the output image that closely approximates a reference image. Hence, the pixels in the given region are now deblurred after distortion-correction, ensuring that visual content of a corresponding region in the real-world environment is highly accurate and realistic. It will be appreciated that utilising the at least one neural network for performing the undistortion deblurring operation allows for highly accurate undistortion deblurring across different regions of the VST image. This may potentially improve an overall viewing experience of the user. Optionally, the input of the at least one neural network further comprises the scaling ratio between the resolution of the at least one VST camera and the resolution of the display whereat the VST image is to be displayed (upon undistortion deblurring). It will be appreciated that the at least one neural network can be trained to hallucinate (namely, generate or reconstruct) missing or unclear visual details in ways that are specifically adapted to different scaling ratios between the resolution of the at least one VST camera and the resolution of the display. In this regard, it means that the at least one neural network could learn to at least one of: add or refine details differently depending on a given scaling ratio, compensate for regions where upscaling may result in certain artifacts or blurs that would be significantly visible, produce outputs that account for how details need to appear when an image captured at a lower resolution is displayed at a higher resolution.

Optionally, the at least one neural network is at least one of: a convolutional neural network (CNN), a U-net type neural network, an autoencoder, a Residual Neural Network (ResNet), a Vision Transformer (ViT), a neural network having self-attention layers, a generative adversarial network (GAN), a diffusion neural network. The technical effect of utilising any of the aforesaid forms of the at least one neural network is that it enables a robust and versatile approach for performing the undistortion deblurring operation on the given region of the VST image, allowing for effective adaptation to varying degrees of distortion and blur whilst preserving critical image details. Thus, blurring that is introduced upon correcting distortion of the VST image is accurately mitigated. This facilitates in improving an overall viewing experience of the user, when distortion-corrected, deblurred images are displayed to the user.

The “convolution neural network” is a type of a neural network that is designed for processing and analysing visual data, particularly effective in tasks such as image restoration, deblurring, and similar, in images. It will be appreciated that the CNN may extract spatial features in the VST image through multiple convolutional layers, which detect patterns related to distortions and blurs. The CNN predicts optimal pixel values based on differences between blurred images and corresponding reference images, enabling to dynamically compensate for identified blurring. The CNN is well-known in the art. The “U-net type neural network” is a neural network that is based on a typical U-net neural network. Typically, the U-net type neural network consists of an encoder-decoder framework, where the encoder progressively captures high-level features from the VST image (i.e., an input image) while reducing its spatial dimensions, and the decoder reconstructs the output image by upsampling and refining these features. Notably, skip connections between corresponding layers in the encoder and the decoder paths facilitate the preservation of spatial information, enabling the U-net type neural network to effectively recover fine details in the output image. This architecture enables for a more accurate restoration of the VST image by maintaining essential contextual information while correcting distortions and blurs, thus improving the overall quality and clarity of the visual content presented to the user. The U-net type neural network is well-known in the art.

The “autoencoder” is a type of a neural network wherein an image frame is encoded into a lower-dimensional representation, and then the encoded image frame is decoded back to its original dimensionality. Such encoding and decoding operations are performed by said neural network using an encoder and a decoder, respectively. The autoencoder is trained in a manner that an encoded representation of an original image frame captures all its prominent features, and thus a reconstruction error between the original image frame and a decoded image frame is minimised. The autoencoder is well-known in the art. The “Residual Neural Network” is a type of a neural network designed to address challenges associated with training very deep convolutional neural networks for image processing tasks. Optionally, the Residual Neural Network (ResNet) performs the undistortion deblurring operation on the given region of the VST image by utilizing its unique architecture of skip connections, which facilitate learning of complex features in the VST image. The ResNet is well-known in the art.

The term “Vision Transformer” refers to a type of the at least one neural network specifically designed for image processing tasks, which leverages transformer model originally developed for natural language processing. The ViT is well-known in the art. The term “neural network having self-attention layers” refers to a type of the at least one neural network that incorporates self-attention mechanisms, allowing the model to weigh importance of different parts of input data (namely, the VST image) when making predictions. This architecture is particularly beneficial for processing sequential or spatial data, such as images, as it enables the network to capture long-range dependencies and relationships between pixels effectively. The neural network having self-attention layers is well-known in the art.

The term “generative adversarial network” is a type of a neural network that comprises two neural networks, a generator and a discriminator. Optionally, the generative adversarial network (GAN) performs the undistortion deblurring operation on the given region of the VST image by leveraging interaction between the generator and the discriminator. The GAN is well-known in the art. Furthermore, the term “diffusion neural network” is a type of a neural network that generates images by modelling the process of diffusion in a latent space. Optionally, the diffusion neural network (DNN) performs the undistortion deblurring operation on the given region of the VST image by employing a two-step processes (namely, a forward diffusion and a reverse diffusion). The DNN is well-known in the art.

Optionally, the method further comprising:
obtaining information indicative of a gaze direction by processing gaze-tracking data; and
   determining the given region of the VST image, based further on the gaze direction.

In this regard, the term “gaze direction” refers to a direction in which a given eye of the user is gazing. The gaze direction may be represented by a gaze vector. Optionally, the gaze-tracking data comprises at least one of: gaze point coordinates, fixation durations, saccadic movements. Optionally, the gaze-tracking data is collected by gaze-tracking means. The term “gaze-tracking means” refers to specialized equipment for detecting and/or following a gaze of the user's eyes. The gaze-tracking means could be implemented as contact lenses with sensors, cameras monitoring a position, a size and/or a shape of a pupil of the user's eye, and the like. The gaze-tracking means are well-known in the art. The collected gaze-tracking data is then processed by the at least one processor to extract information that indicates the user's gaze direction. Such a processing may employ algorithms that analyse eye positions and movement patterns to determine focal points, for identifying the given region of the VST image that corresponds to where the user is looking. Optionally, when determining the given region of the VST image, the at least one processor is configured to map the gaze direction onto a field of view of the VST image. The given region of the VST image is at least one of: the gaze region, the peripheral region surrounding the gaze region. The given region is prioritised for the undistortion deblurring operations, enabling for targeted visual enhancement to improve visual clarity of interest of the user. Additionally, by focusing computational resources on regions of interest, the method enhances performance and reduces processing time, ultimately providing a more intuitive and responsive user experience in dynamic environments. A technical effect of the aforementioned feature is that it enables for enhanced user interaction by accurately identifying and prioritizing the given region of the VST image that aligns with the gaze direction of the user.

Optionally, the step of performing the undistortion deblurring operation is performed further based on at least one of: (i) optical depths in a segment of a depth map corresponding to the given region of the VST image, (ii) a focus depth employed for capturing the VST image, (iii) the scaling ratio between the resolution of the at least one VST camera and the resolution of the display whereat the VST image is to be displayed, (iv) a downscaled resolution of the at least one VST camera, (v) a temperature-induced variation in a given parameter of the at least one VST camera. In this regard, the term “depth map” refers to a two-dimensional representation of a scene where each pixel comprises information pertaining an optical distance between a given camera and a given object present in the real-world environment. In some implementations, the depth map is captured using a depth camera. In other implementations, the depth map is generated using at least one stereo pair of VST images. It will be appreciated that there could several ways to determine an object distance from the camera (namely, the optical depths), for example, using at least one of: tracking systems (uses object or pose tracking to infer distances in 3D space, object database (relies on known objects with predefined distances from a database), neural networks (analyses regular RGB images to estimate object depth using machine learning).

For the given region of the VST image, the at least one of: the deblurring deconvolution filter, the at least one neural network, extracts the depth values corresponding to that specific segment of the depth map. These depth values indicate relative distance of objects in the real-world environment from the camera. The optical depths are taken into account when performing the undistortion deblurring operation because objects at different optical depths may experience varying degrees of blurring due to factors (for example, such as an optical focus, a motion, an optical aberration, and the like). Therefore, the at least one of: the deblurring deconvolution filter, the at least one neural network utilised the optical depths to selectively apply deblurring based on a spatial context of the objects in the real-world environment. For example, objects closer to the camera may require different deblurring parameters compared to objects away from the camera, due to differences in how blurring affect them. Beneficially, by taking into account the depth data, when performing the undistortion deblurring operation, over-sharpening or under-sharpening of objects that are at varying distances within the given region may likely be prevented. Thus, the undistortion deblurring operation is performed based on the depth information, ensuring that the output image has improved clarity across all relevant depth layers within the given region of the VST image. This results in a more realistic and visually coherent output image.

Further, the term “focus depth” refers to a distance from the camera at which a lens is focused when capturing the VST image. The focus depth determines a focal plane where objects appear to be sharp/in-focus in the VST image, while objects positioned closer or farther from this plane may appear out-of-focus/blurred due to limitations of the camera lens. In the context of the undistortion deblurring operation, the focus depth is used to adjust processing based on focal settings of the at least one VST camera, ensuring that the VST image correction aligns with the focus depth at which the scene is most clearly captured. Since the at least one VST camera could be an auto-focus camera, different VST images could be captured with by employing different focus depths. As the auto-focus adjusts between frames, the focus depth for each VST image is recorded. This depth value is used by the at least one of: the deblurring deconvolution filter, the at least one neural network to understand which parts of the scene were captured in-focus and which parts were out-of-focus. For each VST image, the at least one of: the deblurring deconvolution filter, the at least one neural network identifies regions that were at or near a current focus depth. These regions are subject to minimal deblurring correction since they are captured sharp in the VST image. In this regard, regions farther from the focus depth, either too close or too far, will be corrected more aggressively to counteract the blur introduced by being out of focus. It will be appreciated that applying minimal correction to in-focus regions and more aggressive correction to out-of-focus regions, the output image maintains higher clarity and visual fidelity. A technical effect of performing the undistortion deblurring operation based on the optical depths and/or the focus depth is that it enables more precise and context-aware undistortion deblurring operation by leveraging both the depth map and the focus depth. This results in enhanced image clarity and fidelity, ensuring that objects at varying distances are appropriately corrected while preserving spatial relationships and depth cues.

Furthermore, the resolution of the at least one VST camera is a resolution at which the at least one VST camera is controlled to capture the VST image, whereas the resolution of the display is a resolution at which the VST image is displayed at the display. The resolution of the at least one VST camera and the resolution of the display could, for example, be in terms of pixels per degree (PPD). It will be appreciated that when the scaling ratio is high (i.e., when a PPD provided by the display is greater than a PPD provided by the at least one VST camera), even small blurs in the VST image would likely become much more noticeable if the VST image would be displayed as-is (without applying the undistortion deblurring operation). This means that any blur present in the VST image gets “scaled up” or magnified on the display. If the PPD provided by the display is greater than the PPD provided by the at least one VST camera, then even minor blur in the (original) VST image appears larger on the display, as a low-resolution output (namely, the (original) VST image) from the at least one VST camera is stretched to meet a high-resolution output at the display. For example, a one-pixel blur in the VST image could be displayed using several pixels on the display, making said blur more visible and, potentially, distracting to the user. In order to mitigate this potential problem, the undistortion deblurring operation would be performed by taking into account the scaling ratio. In cases where the PPD provided by the display is considerably higher than that of the at least one VST camera, deblurring becomes crucial to prevent the blur from being visibly magnified. To handle this, the undistortion deblurring would be applied more aggressively, as the scaling factor significantly influences a perceived blur effect in an image rather than just camera lens characteristics alone.

Moreover, a resolution of the VST image that is captured by the at least one VST camera may be downscaled to manage data throughput efficiently, especially in scenarios requiring high frame rates or bandwidth-limited processing, for example, in XR applications. Such a downscaling reduces a pixel density of the VST image, which can introduce a blur when displayed via the display at a higher resolution. Beneficially, the undistortion deblurring operation is performed by taking into account such a loss of visual detail to effectively restore clarity of the VST image, especially in high-resolution displays where scaled-down blurs are more noticeable. Additionally or alternatively, optionally, changes in a temperature of a real-world environment (whereat the at least one VST camera is employed) can affect parameters (for example, such as an optical distortion, a focal length, a focus plane, an aperture stability, and the like) of the at least one VST camera. In an example, as the focal length shifts due to increase or decrease in the temperature, the distortion profile of the camera lens changes, potentially altering how image distortion appears across a field of view of the VST image. This means that temperature fluctuations can affect an accuracy of distortion correction. Beneficially, to maintain clear visuals, the undistortion deblurring operation is performed based on such temperature-driven changes in the parameters, ensuring a consistent deblurring of the VST image across varying environmental conditions.

Optionally, the method further comprises utilising the at least one neural network to perform at least one of: a defocus deblurring operation, a motion deblurring operation, a super-resolution operation, a sharpening operation, a denoising operation, an inpainting operation, an edge enhancement operation, a contrast enhancement operation, a colour enhancement operation, a style transfer operation, an auto white-balancing operation, a low-light enhancement operation, a tone mapping operation, an exposure correction operation, a saturation correction operation, a rolling shutter correction operation. The technical benefit of utilising the at least one neural network for performing at least one of the aforesaid operations is that the output image would be highly accurately and realistically generated, even in a case when there are some other artifacts or image-quality deficiencies (for example, such as a motion blur, a high noise, a low resolution, a defocus blur, a low contrast, missing or obliterated parts, inadequate colour balance, and the like) present in the (distortion-corrected) VST image. This improves an overall viewing experience of the user (for example, in terms of realism and immersiveness), when the output images are displayed to the user.

The term “defocus deblurring operation” refers to an image processing operation that is capable of mitigating or removing a blurriness from a given image, which results from objects being out of focus during capturing process of the given image. The term “motion deblurring operation” refers to an image processing operation that is designed to reduce or eliminate blurriness in the given image that occurs due to motion during capturing process of the given image. The term “super-resolution operation” refers to an image processing operation that enhances a resolution of the given image by generating high-frequency details from one or more low-resolution images. The term “sharpening operation” refers to an image processing operation that enhances a visibility of edges and fine details in the given image by increasing a contrast between adjacent/neighbouring pixels. The term “denoising operation” refers to an image processing operation that reduces or eliminates noise from the given image, which may arise from various sources such as sensor limitations, environmental conditions, low-light scenarios, and similar. The term “inpainting operation” refers to an image processing operation used to restore or reconstruct missing or corrupted parts of the given image. The term “edge enhancement operation” refers to an image processing operation used to improve visibility and definition of edges in the given image. The term “contrast enhancement operation” refers to an image processing operation that increases a difference in a luminance or a colour within the given image, making objects more distinguishable from each other and a background in the given image. The term “colour enhancement operation” refers to an image processing operation that improves a visual appearance of the given image by adjusting and optimizing colour properties of the given image. The term “style transfer operation” refers to an image processing operation in which visual style of one image (such as its colour, texture, brushstrokes) is applied to another image while preserving an original content and structure of the latter image. The term “auto white-balancing operation” refers to an image processing operation that adjusts colours in the given image to ensure that white objects appear neutral, compensating for colour casts caused by different lighting conditions. The term “low-light enhancement operation” refers to an image processing operation that improves visibility and quality of the given image captured in low-light conditions. The term “tone mapping operation” refers to an image processing operation used to convert high dynamic range (HDR) images into a format that can be displayed on standard dynamic range (SDR) displays while preserving the visual appearance of an original image. The term “exposure correction operation” refers to an image processing operation that modifies brightness levels of the given image to attain a specified exposure level, enhancing visibility details in the given image. The term “saturation correction operation” refers to an image processing operation that modifies intensity of colours in the given image to achieve a more vivid and balanced representation. The term “rolling shutter correction operation” refers to an image processing operation designed to rectify distortions and artifacts in the given image caused by rolling shutter effect commonly associated with certain camera technologies, including those utilizing Complementary Metal-Oxide-Semiconductor (CMOS) sensors. All the aforesaid image processing operations are well-known in the art.

Optionally, the method further comprises providing information indicative of the gaze direction as an input to the at least one neural network, wherein the given region of the VST image is determined based on said gaze direction. In this regard, instead of determining the given region of the VST image by the at least one processor itself, the information indicative of the gaze direction is provided to the at least one neural network, for determining the given region of the VST image, in a similar manner as discussed earlier. The technical benefit of this is that the given region of the VST image is highly accurately determined, with minimal computational resources and time. Moreover, by providing the information indicative of the gaze direction as the input, the at least one neural network could adjust its processing dynamically to prioritise aspects of the VST image that are perceptually important to a human vision. For example, the at least one neural network can enhance a noise reduction in the given part of the VST image, while minimising a loss of sharpness in said given part, or the at least one neural network can emphasise on certain focussing cues, for example, making edges sharper and more contrasted in the given part, which are crucial for improving visual perception of the output image. Additionally, a colour accuracy can also be enhanced in the given part when the information indicative of the gaze direction is known, ensuring that the output image better matches a human perception of colours. In one case, the gaze direction could be a gaze direction of a single user. In another case, the gaze direction could be an average gaze direction for multiple users. In yet another case, the gaze direction could be a default gaze direction (for example, towards a central region of the input image). Information pertaining to the gaze direction has been already discussed earlier in detail.

The present disclosure also relates to the system as described above. Various embodiments and variants disclosed above, with respect to the aforementioned first aspect, apply mutatis mutandis to the system.

Optionally, the system further comprising gaze-tracking means, wherein the at least one processor is configured to:
process gaze-tracking data, collected by the gaze-tracking means, to obtain information indicative of a gaze direction; and
   determine the given region of the VST image, based further on the gaze direction.

Optionally, the given region is at least one of: a gaze region of the VST image, at least a part of a peripheral region of the VST image.

Optionally, the at least one processor is configured to perform the undistortion deblurring operation, based further on at least one of: (i) optical depths in a segment of a depth map corresponding to the given region of the VST image, (ii) a focus depth employed for capturing the VST image, (iii) the scaling ratio between the resolution of the at least one VST camera and the resolution of the display whereat the VST image is to be displayed, (iv) a downscaled resolution of the at least one VST camera, (v) a temperature-induced variation in a given parameter of the at least one VST camera.

Optionally, the at least one processor is configured to utilise the at least one neural network to perform at least one of: a defocus deblurring operation, a motion deblurring operation, a super-resolution operation, a sharpening operation, a denoising operation, an inpainting operation, an edge enhancement operation, a contrast enhancement operation, a colour enhancement operation, a style transfer operation, an auto white-balancing operation, a low-light enhancement operation, a tone mapping operation, an exposure correction operation, a saturation correction operation, a rolling shutter correction operation.

Optionally, the at least one processor is configured to provide information indicative of the gaze direction as an input to the at least one neural network, wherein the given region of the VST image is determined based on said gaze direction.

Optionally, in the system, the scaling ratio between the resolution of the at least one VST camera and the resolution of the display is spatially varying across a field of view of the VST image.

### DETAILED DESCRIPTION OF THE DRAWINGS

Referring to FIG. 1, illustrated are steps of a method for deblurring distortion-corrected images, in accordance with an embodiment of the present disclosure. At step 102, a video-see-through (VST) image of a real-world environment is obtained. At step 104, a given region of the VST image is determined, based on at least one of: a distortion profile of a camera lens of at least one VST camera, blur characteristics of said camera lens, a scaling ratio between a resolution of the at least one VST camera and a resolution of a display whereat the VST image is to be displayed. At step 106, an undistortion deblurring operation is performed on the given region of the VST image, by utilising at least one of: (i) a deblurring deconvolution filter, (ii) at least one neural network, based on locations of pixels of the given region, to generate an output image.

The aforementioned steps are only illustrative and other alternatives can also be provided where one or more steps are added, one or more steps are removed, or one or more steps are provided in a different sequence without departing from the scope of the claims herein.

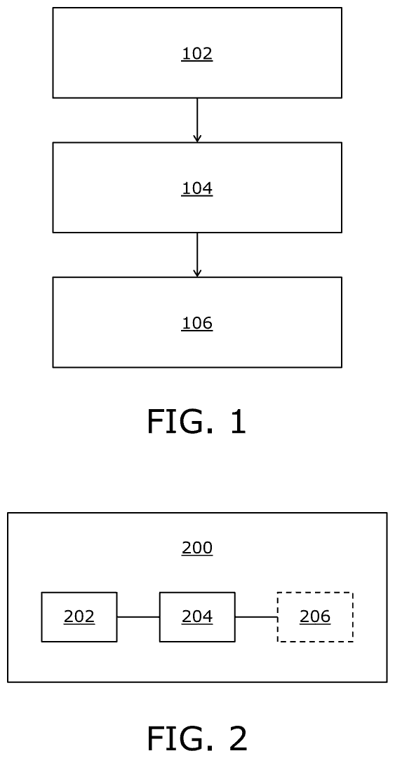

Referring to FIG. 2, illustrated is a block diagram of an architecture of a system 200 for deblurring distortion-corrected images, in accordance with an embodiment of the present disclosure. The system 200 comprises at least one video-see-through (VST) camera (for example, depicted as a VST camera 202) and at least one processor (for example, depicted as a processor 204). Optionally, the system 200 further comprises gaze-tracking means 206. The processor 204 is communicably coupled to the VST camera 202, and optionally, to the gaze-tracking means 206. The processor 204 is configured to perform various operations, as described earlier with respect to the aforementioned second aspect.

It may be understood by a person skilled in the art that FIG. 2 includes a simplified architecture of the system 200, for sake of clarity, which should not unduly limit the scope of the claims herein. It is to be understood that the specific implementation of the system 200 is provided as an example and is not to be construed as limiting it to specific numbers or types of VST cameras, gaze-tracking means, and processors. The person skilled in the art will recognize many variations, alternatives, and modifications of embodiments of the present disclosure.

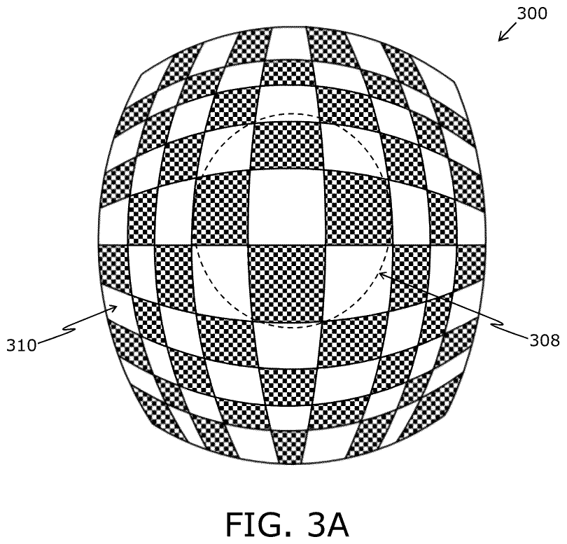

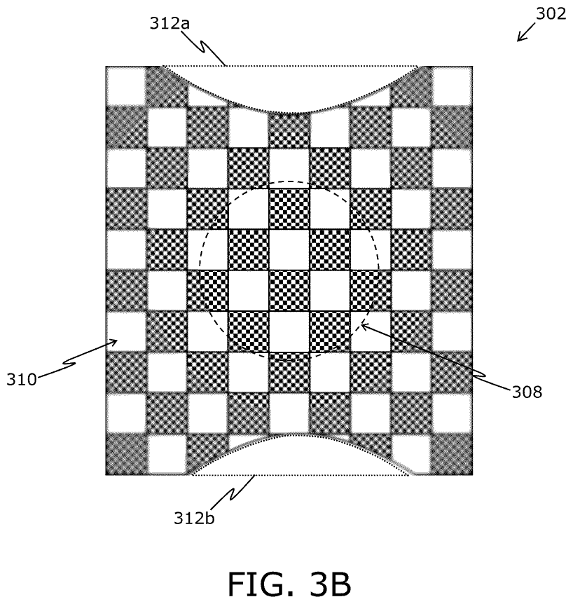

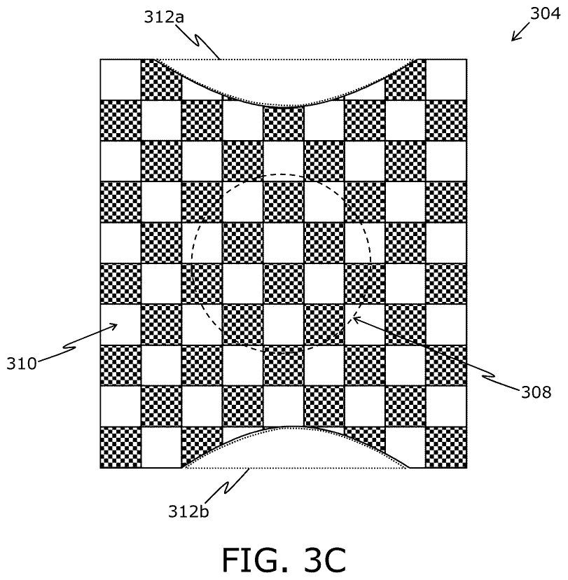

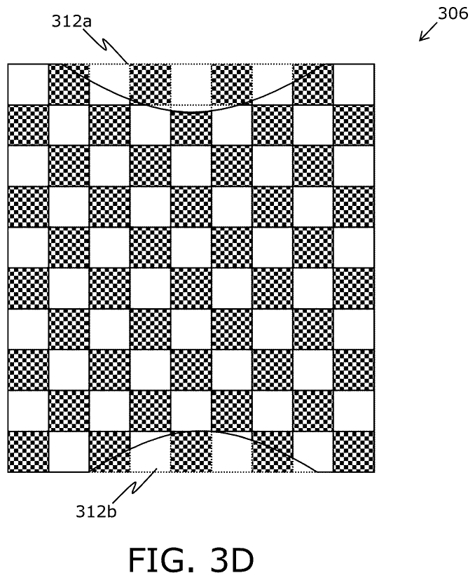

Referring to FIGS. 3A, 3B, 3C, and 3D, FIG. 3A illustrates an exemplary video-see-through (VST) image 300 captured using a VST camera, FIG. 3B illustrates an exemplary distortion-corrected VST image 302, FIG. 3C illustrates an exemplary output image 304, while FIG. 3D illustrates an exemplary in-painted output image 306, in accordance with an embodiment of the present disclosure.

With reference to FIG. 3A, the VST image 300 is captured by a camera lens of the VST camera, and is shown to comprise a checkerboard pattern, for sake of simplicity and clarity. Due to an inherent distortion introduced by the camera lens, the VST image 300 has a geometric distortion (such as a barrel distortion), wherein the geometric distortion is noticeable in a gaze region 308 (depicted using a dashed circle) and a peripheral region 310 of the VST image 300, wherein the peripheral region 310 surrounds the gaze region 308. For sake of simplicity, the gaze region 308 is shown as a central region of the VST image. As shown, the geometric distortion causes a curvature of straight lines present in the checkerboard pattern, resulting from optical characteristics of the camera lens affecting a spatial consistency and a geometry of the VST image 300. In the gaze region 308, the geometric distortion remains relatively moderate; however, as a distance from a gaze point increases, an intensity of the geometric distortion also increases. Moreover, edges of the peripheral region 310 also has a blur, in addition to the geometric distortion.

With reference to FIG. 3B, the distortion-corrected VST image 302 is generated by correcting the geometric distortion in the VST image 300 (as shown in FIG. 3A). As shown, the straight lines present in the checkerboard pattern are significantly linear. However, due the geometric correction (namely, upon undistortion of the VST image 300), a noticeable blurring is introduced in the peripheral region 310, and a sharpness of the distortion-corrected VST image 302 is compromised. There are also shown two missing parts 312a and 312b (depicted using dotted-line shapes) in the distortion-corrected VST image 302, upon said undistortion. With reference to FIG. 3C, the output image 304 is generated by performing an undistortion deblurring operation on the distortion-corrected VST image 302, by utilising at least one of: (i) a deblurring deconvolution filter (DCF), (ii) at least one neural network (NN), based on locations of pixels of each region in the distortion-corrected VST image 302. As shown, the undistortion deblurring operation mitigates the blurring introduced in the peripheral region 310, and a sharpness of the distortion-corrected VST image 302 is restored. As a result, the generated output image 300c has a uniform sharpness and geometric accuracy across all its regions. With reference to FIG. 3D, the in-painted output image 306 is generated by performing an inpainting operation on the output image 304. As shown, the two missing parts 312a and 312b are reconstructed, upon performing said inpainting operation.

FIGS. 3A, 3B, 3C, and 3D are merely examples, which should not unduly limit the scope of the claims herein. A person skilled in the art will recognize many variations, alternatives, and modifications of embodiments of the present disclosure.

1. A method for deblurring distortion-corrected images, wherein the method comprises:
obtaining a video-see-through (VST) image of a real-world environment;
determining a given region of the VST image, based on at least one of: a distortion profile of a camera lens of at least one VST camera, blur characteristics of said camera lens, a scaling ratio between a resolution of the at least one VST camera and a resolution of a display whereat the VST image is to be displayed; and
performing an undistortion deblurring operation on the given region of the VST image, by utilising at least one of: (i) a deblurring deconvolution filter, (ii) at least one neural network, based on locations of pixels of the given region, to generate an output image.

2. The method of claim 1, further comprising:
obtaining information indicative of a gaze direction by processing gaze-tracking data; and
determining the given region of the VST image, based further on the gaze direction.

3. The method of claim 1, wherein the given region is at least one of: a gaze region of the VST image, at least a part of a peripheral region of the VST image.

4. The method of claim 1, wherein the step of performing the undistortion deblurring operation is performed further based on at least one of: (i) optical depths in a segment of a depth map corresponding to the given region of the VST image, (ii) a focus depth employed for capturing the VST image, (iii) the scaling ratio between the resolution of the at least one VST camera and the resolution of the display whereat the VST image is to be displayed, (iv) a downscaled resolution of the at least one VST camera, (v) a temperature-induced variation in a given parameter of the at least one VST camera.

5. The method of claim 1, wherein the deblurring deconvolution filter has a spatially-varying deblurring kernel.

6. The method of claim 1, wherein the method further comprises utilising the at least one neural network to perform at least one of: a defocus deblurring operation, a motion deblurring operation, a super-resolution operation, a sharpening operation, a denoising operation, an inpainting operation, an edge enhancement operation, a contrast enhancement operation, a colour enhancement operation, a style transfer operation, an auto white-balancing operation, a low-light enhancement operation, a tone mapping operation, an exposure correction operation, a saturation correction operation, a rolling shutter correction operation.

7. The method of claim 1, wherein the deblurring deconvolution filter is any one of: a wiener filter, a Lucy-Richardson deconvolution filter.

8. The method of claim 1, wherein the at least one neural network is at least one of: a convolutional neural network (CNN), a U-net type neural network, an autoencoder, a Residual Neural Network (ResNet), a Vision Transformer (ViT), a neural network having self-attention layers, a generative adversarial network (GAN), a diffusion neural network.

9. The method of claim 1, wherein the method further comprises providing information indicative of the gaze direction as an input to the at least one neural network, wherein the given region of the VST image is determined based on said gaze direction.

10. The method of claim 1, wherein the scaling ratio between the resolution of the at least one VST camera and the resolution of the display is spatially varying across a field of view of the VST image.

11. A system for deblurring distortion-corrected images, wherein the system comprises:
at least one video-see-through (VST) camera; and
at least one processor configured to:
control the at least one VST camera to capture a VST image of a real-world environment;
determine a given region of the VST image, based on at least one of: a distortion profile of a camera lens of at least one VST camera, blur characteristics of said camera lens, a scaling ratio between a resolution of the at least one VST camera and a resolution of a display whereat the VST image is to be displayed; and
perform an undistortion deblurring operation on the given region of the VST image, by utilising at least one of: (i) a deblurring deconvolution filter, (ii) at least one neural network, based on locations of pixels of the given region, to generate an output image.

12. The system of claim 11, further comprising gaze-tracking means, wherein the at least one processor is configured to:
process gaze-tracking data, collected by the gaze-tracking means, to obtain information indicative of a gaze direction; and
determine the given region of the VST image, based further on the gaze direction.

13. The system of claim 11, wherein the given region is at least one of: a gaze region of the VST image, at least a part of a peripheral region of the VST image.

14. The system of claim 11, wherein the at least one processor is configured to perform the undistortion deblurring operation, based further on at least one of: (i) optical depths in a segment of a depth map corresponding to the given region of the VST image, (ii) a focus depth employed for capturing the VST image, (iii) the scaling ratio between the resolution of the at least one VST camera and the resolution of the display whereat the VST image is to be displayed, (iv) a downscaled resolution of the at least one VST camera, (v) a temperature-induced variation in a given parameter of the at least one VST camera.

15. The system of claim 11, wherein the at least one processor is configured to utilise the at least one neural network to perform at least one of: a defocus deblurring operation, a motion deblurring operation, a super-resolution operation, a sharpening operation, a denoising operation, an inpainting operation, an edge enhancement operation, a contrast enhancement operation, a colour enhancement operation, a style transfer operation, an auto white-balancing operation, a low-light enhancement operation, a tone mapping operation, an exposure correction operation, a saturation correction operation, a rolling shutter correction operation.

16. The system of claim 11, wherein the at least one processor is configured to provide information indicative of the gaze direction as an input to the at least one neural network, wherein the given region of the VST image is determined based on said gaze direction.
